(19) United States
(12) Patent Application Publication
(10) Pub. No.: US 2024/0119290 A1
(43) Pub. Date: Apr. 11, 2024

(54) MANAGING DATA DRIFT IN MACHINE LEARNING MODELS USING INCREMENTAL LEARNING AND EXPLAINABILITY

(71) Applicant: Cypress Semiconductor Corporation, San Jose, CA (US)

(72) Inventors: Niall LYONS, Irvine, CA (US); Amab Neelim MAZUMDER, Arbutus, MD (US); Avik SANTRA, Irvine, CA (US); Anand DUBEY, Munchen (DE); Ashutosh PANDEY, Irvine, CA (US)

(73) Assignee: Cypress Semiconductor Corporation, San Jose, CA (US)

(21) Appl. No.: 18/178,351

(22) Filed: Mar. 3, 2023

Related U.S. Application Data
(60) Provisional application No. 63/413,725, filed on Oct. 6, 2022.

(51) Int. Cl. G06N 3/082

(52) U.S. Cl. CPC G06N 3/082

(57) ABSTRACT

Implementations disclosed include methods and systems that include obtaining, by a processing device, a first output from a machine learning model, wherein the first output comprises one or more data samples; identifying a first set of data samples of the one or more data samples that satisfies a threshold criterion; generating, using an explainability tool, a weighted value for each data sample of the first set of data samples; and modifying the machine learning model based at least in part on the weighted value for each data sample of the first set of data samples.

### RELATED APPLICATIONS

This application claims the benefit of priority of U.S. Provisional Application No. 63/413,725, filed Oct. 6, 2022, which is herein incorporated by reference in its entirety.

### TECHNICAL FIELD

The present disclosure pertains to machine learning models, and more specifically, to managing data drift in neural networks using incremental learning and explainability.

### BACKGROUND

Computing devices, such as automotive, wearable, hand-held, metering, appliance integrated, and the like, often rely on the use of machine learning models in making and improving predictions for embedded systems. A neural network is a computational machine learning model that implements a multitude of connected nodes called “artificial neurons,” such that each artificial neuron processes one or more input signals (including a bias signal) and transmits the output signal to one or more neighboring artificial neurons. The output of an artificial neuron can be computed by applying its activation function to a linear and/or nonlinear combination of its inputs. A neural network can be trained by processing examples (e.g., training data sets) to perform feature extraction, regression, and/or classification tasks without being programmed with any task-specific rules.

### BRIEF DESCRIPTION OF THE DRAWINGS

FIG. 1 is a block diagram of an example system for managing data drift in neural networks using incremental learning and explainability, in accordance with some implementations.

FIG. 2 illustrates an example LIME (Local Interpretable Model Agnostic Explanations) visualization process, in accordance with some implementations.

FIG. 3 is a flow diagram of an example method for managing data drift in neural networks using incremental learning and explainability, in accordance with some implementations.

FIG. 4 is a flow diagram of an example method for managing data drift in neural networks using incremental learning and explainability, in accordance with some implementations.

FIG. 5 depicts a block diagram of an example computing device, operating in accordance with one or more aspects of the present disclosure.

### DETAILED DESCRIPTION

Embedded systems employ the use of machine learning models, and specifically the use of neural network models, in various applications to enable the embedded systems to make predictions that can be used in decision making. A neural network is a computational model that implements a multitude of connected nodes called “artificial neurons,” such that each artificial neuron processes one or more input signals (including a bias signal) and transmits the output signal to one or more neighboring artificial neurons. The output of an artificial neuron can be computed by applying its activation function to a linear and/or nonlinear combination of its inputs. A neural network can be trained by processing examples (e.g., training data sets) to perform feature extraction, regression, and/or classification tasks without being programmed with any task-specific rules.

In certain cases, a trained neural network model can experience data distribution drift (also referred to as “data drift”), which can decrease the accuracy of the neural network model. Data distribution drift can occur due to various reasons, such as changes in input data after a neural network model has already been deployed in an embedded system. To address data distribution drift, the neural network model can be retrained in order to address the change in data distribution. Generally, incremental learning is used in retraining the neural network model. Incremental learning feeds unseen test cases in sequential sessions into an initially trained neural network and allows for focus on rectifying wrong predictions in a sequential fashion. However, several challenges to retraining the neural network model using incremental learning may be present. For example, the trained neural network model may have forgotten any previously learned information. If the neural network model has forgotten previously learned information, the neural network model must be retrained using both the initial data and new data, which can be time-consuming. Further, the initial data may not be available during the retraining. In order to address the challenges posed by incremental learning, certain systems, such as keyword spotting systems (“KWS”), can experience data distribution drift and can thus implement a regularization-based approach to incremental learning to address the data distribution drift.

Using a human-machine interface (e.g., voice assistant) as an example, a spoken KWS system can be used to activate the voice assistant upon hearing a predefined keyword. More specifically, the voice assistant can enter a voice command receiving mode upon hearing the predefined keyword. Using a KWS system can reduce computational expenses when voice assistance is not needed. Thus, a KWS system can be defined as the task of identifying keywords in audio streams, including speech, and has become a fast-growing technology due to the paradigm shift introduced by deep learning (e.g., neural networks). Some KWS systems can utilize continuous KWS to identify the predefined keyword in a continuous speech. One advantage of this approach is the flexibility to deal with changing and/or non-predefined keywords. However, such continuous KWS implementations can have high computational complexity.

Some systems can utilize an internal learning technique in which a learning agent, at timestep t, is trained to recognize tasks 1 through t while the datasets for these tasks D₁ through D t may or may not be available. Knowledge transfer (KT) measures how incremental learning up to task t influences the agent's knowledge about the task. In terms of performance, a positive KT suggests that the agent should deliver better accuracy on the task if it were allowed to incrementally learn the task t through tasks 1 through t−1 while achieving a low validation error on all of the datasets D₁ through Dₜ. On the other hand, semantic transfer (ST) measures the influence that learning a task t has on the performance of a previous task. A positive ST means that learning a new task t would increase model performance with respect to the previously learned tasks 1 through t−1. Accordingly, a trade-off can exist between KT and ST. In some embodiments, a task is a KWS task.

Some incremental learning approaches used to find the trade-off between KT and ST include architecture-based approaches and memory-based approaches. Architecture-based approaches (e.g., progressive nets) evolve network size after every task while assimilating the new knowledge with past knowledge. Memory-based approaches (e.g., gradient episodic memory) can store a memory of each of the previous tasks while learning the new task. However, architecture-based and memory-based approaches can be resource intensive (e.g., processor and/or memory).

As discussed above, certain systems can implement a regularization-based approach to incremental learning. The regularization-based approach can assume a fixed network size and learn new tasks while trying to avoid changes to parameters that are sensitive to previous tasks. The regularization-based approach can be a regularization-based elastic weight consolidation (EWC) approach. A model parameter θ_{1:i-1}* configuration for each of tasks 1 through i−1 can be achieved at the end of dataset Dᵢ, which is expected to solve all datasets D_{1:i}. The posterior maximization over the new task is equivalent to the likelihood maximization for the new dataset and the posterior maximization on the previous dataset. For example:

$${max}_{θ} log p ( θ \vert {D}_{1 : i} ) = {max}_{θ} [ log p ( {D}_{1 : i} \vert θ ) + log p ( θ ) ] = {max}_{θ} [ log p ( {D}_{i} \vert θ ) + log p ( θ \vert {D}_{1 : i - 1} ) \qquad ( 1 )$$

Equation (1) can be minimized by adding a regularization loss, which can prevent θ_{1:i}* from veering too far away from θ_{1:i-1}*. Since this regularization loss should preserve closeness to the previous solution, the Kullback-Leibler (KL)-divergence between p(θ|D_{1:i}) and p(θ|D_{1:i-1}) can be used as the regularization loss. For example,

$$KL ( ( p ( θ \vert {D}_{1 : i} ) ‖ p ( θ \vert {D}_{1 : i - 1} ) ) \approx \frac{1}{2} {\sum }_{j} {{F}_{jj} ( {θ}_{j} - {θ}_{1 : i - 1 , j}^{*} )}^{2} \qquad ( 2 )$$

where Fᵢⱼ refers to the diagonal of the empirical Fisher matrix.

The EWC approach described above can act as a regularizer to prevent catastrophic forgetting (e.g., where adding new data to the training regime may negatively impact the learned distribution and can force the model to perform poorly on previous tasks or examples) by forcing the model to retain existing data while simultaneously incorporating new data. However, the EWC approach can limit the model to learn information from the new data. Although the EWC approach can preserve KT, equation (1) introduces some challenges. One challenge is data-dependent optimization. For example, as optimization is performed using maximum likelihood estimation, the ST can depend highly on the examples used during training and their similarity coefficients. That is, dataset components with less similarity can suffer more semantic loss during ST, and vice versa.

Aspects and implementations of the present disclosure address these and other limitations of the existing technology by enabling systems and methods of managing data distribution drift using incremental learning and explainability. More specifically, embodiments described herein can implement incremental learning by combining the EWC approach with Explainable AI (artificial intelligence) to improve the accuracy of neural network models. Due to the end-to-end nature of a neural network, neural network models can often be considered as “black boxes,” where the reasons for certain outputs or predictions made by neural network models may not be known. Thus, being able to correct for data distribution drift and improve the accuracy of a neural network model can be a challenge. Explainability of neural network prediction is therefore an important tool for understanding feature importance and gaining interpretable insight into neural network performance.

In some embodiments, a set of explanation metrics can be used as a weighting factor during machine learning model optimization to improve semantic transfer learning between tasks. Misclassified samples from a previous task can be taken and included in a new task training set. This can help the machine learning model to imitate memory-based approaches. In some embodiments, an explanation is a local interpretable model-agnostic explanation (LIME), and the set of explanation metrics can include a set of LIME scores. For example, a weighted loss can be used during model training, in which the weights from the samples are derived from the difference between LIME-based visual explanations of the true and predicted classes. As a result, the model can focus more on rectifying incorrect predictions with higher weights, improving the ability to learn new data. In some embodiments, the accuracy of a KWS task can be enhanced by determining the importance of segments within input data (e.g., an input spectrogram) to isolate activity regions. To this end, the LIME-based visual explanations described herein can be used to generate sample weights for weighted loss, which can be used in an incremental learning method to improve the accuracy of machine learning models.

Advantages of the present disclosure can include an improvement in the accuracy of machine learning models, which are often used in various applications within embedded systems, while addressing the challenges posed by data distribution drift and incremental learning. Improving the accuracy of machine learning models can further result in an improvement in performance of the embedded systems utilizing the machine learning models.

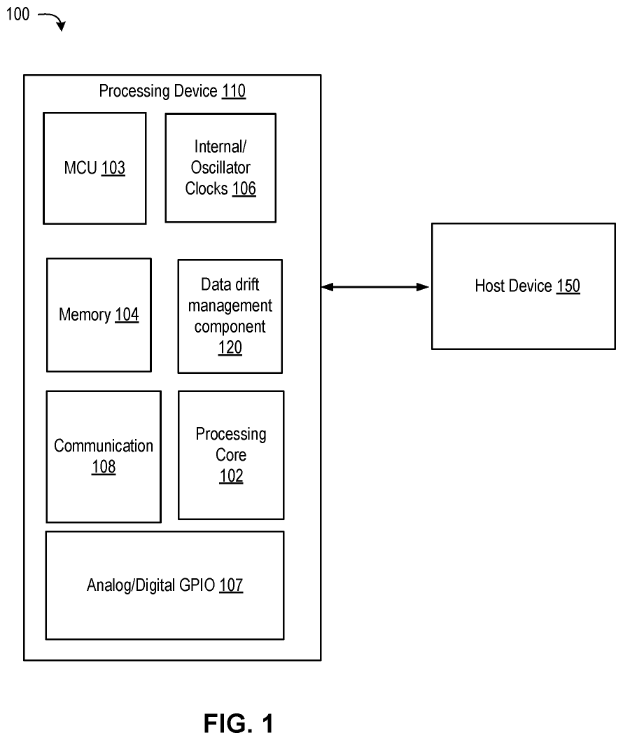

FIG. 1 is a block diagram of an example system 100, in accordance with some implementations of the present disclosure. The system 100 can be integrated within an embedded system, such as a distributed computing and control system of a vehicle, airplane, or other more extensive operation device. The system 100 can include a processing device 110 for managing data drift in neural networks using incremental learning and explainability, in accordance with some implementations of the present disclosure. The system 100 can also include a host device 150.

The processing device 110 can include an analog and/or digital general-purpose input/output (“GPIO”) ports 107. The GPIO ports 107 can be coupled to a Programmable Interconnect and Logic (“PIL”), which acts as an interconnect between GPIO ports 107 and a digital block array of the processing device 110 (not shown). The digital block array can be configurable to implement a variety of digital logic circuits (e.g., DAC, digital filters, or digital control systems) using, in one embodiment, configurable user modules (“UMs”). The digital block array may be coupled to a system bus. Processing device 110 can also include memory 104, such as random-access memory (“RAM”) and program flash. RAM can be static RAM (“SRAM”), and program flash can be a non-volatile storage, which may be used to store firmware (e.g., control algorithms executable by processing core 102 (e.g., a central processing unit (CPU)) to implement operations described herein). Processing device 110 can also include a memory controller unit (“MCU”) 103 coupled to the memory 104 and the processing core 102. In some implementations, the MCU 103 can implement the management of data drift in neural networks using incremental learning and explainability, in accordance with some implementations of the present disclosure. The processing core 102 is a processing element configured to execute instructions or perform operations. The processing device 110 can include other processing elements as would be appreciated by one or ordinary skill in the art having the benefit of this disclosure. It should also be noted that the memory 104 can be internal to the processing device or external. In the case of the memory 104 being internal, the memory 104 can be coupled to a processing element, such as the processing core 102. In the case of the memory 104 being external to the processing device 110, the processing device 110 can be coupled to the other device in which the memory 104 resides, as would be appreciated by one of ordinary skill in the art having the benefit of this disclosure.

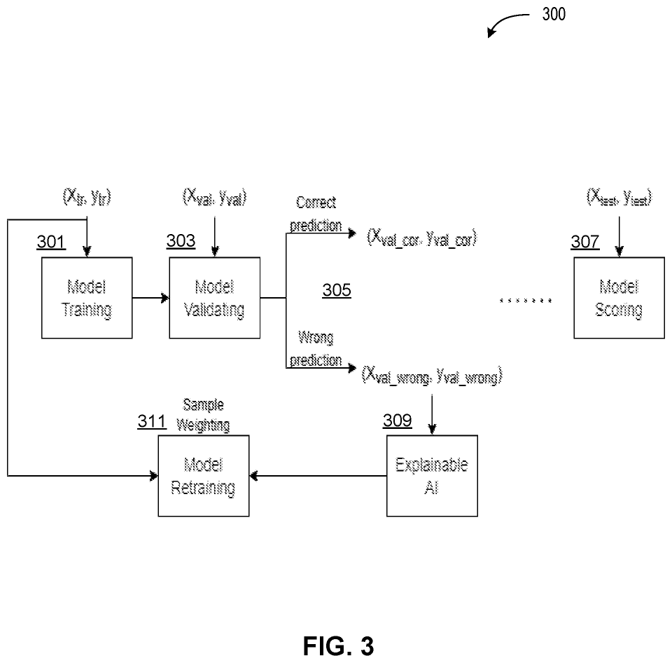

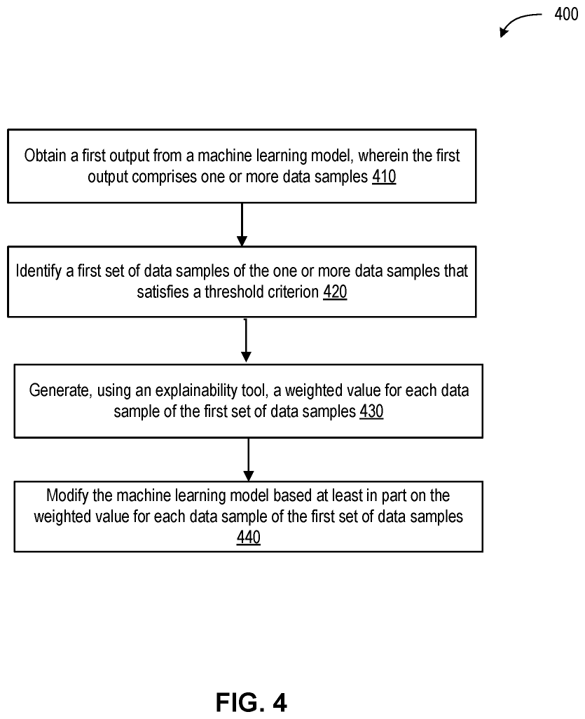

The processing device 110 can also include an analog block array (not shown). The analog block array can be coupled to a system bus (not shown). The analog block array can also be configurable to implement a variety of analog circuits (e.g., ADCs or analog filters) using, in one embodiment, configurable UMs. The analog block array can also be coupled to the GPIO 107. As illustrated, a data drift management component 120 can be integrated into the processing device 110. The data drift management component 120 can include analog I/O coupled to an external component. The data drift management component 120 can be configurable to implement the management of data drift in neural networks using incremental learning and explainability as described with references to methods 300 and 400 of FIGS. 3-4. In some implementations, the data drift management component 120 can be implemented using the MCU 103.

The processing device 110 can also include internal oscillator/clocks 106 and communication component 108. The internal oscillator/clocks 106 can provide clock signals to one or more components of the processing device 110. The communication component 108 can be used to communicate with an external component, such as the host device 150, via a host interface over a network. In some implementations, the processing device 110 can be coupled to an embedded controller to communicate with the external components, such as the host device 150. In some implementations, the processing device 110 is configurable to communicate with the host device 150 to send and/or receive data.

The host device 150 can be any desktop computer, laptop computer, tablet, phone, smart TV, sensor, appliance, system controller (e.g., an air conditioning, heating, water heating controller), component of a security system, medical testing, monitoring equipment, or any other type of a device. The host device 150 can be coupled (e.g., via a wired and/or wireless connection) to a respective wireless device of the system 100. In some implementations, the wireless device can be implemented as an integrated circuit (IC) device (e.g., disposed on a single semiconductor die).

In some implementations, the system 100 can include other elements not shown in FIG. 1, such as user interface devices (e.g., a mouse, a keyboard, etc.). Numerous other implementations and multiple variations of these implementations with regard to the data drift management component 120 are discussed below.

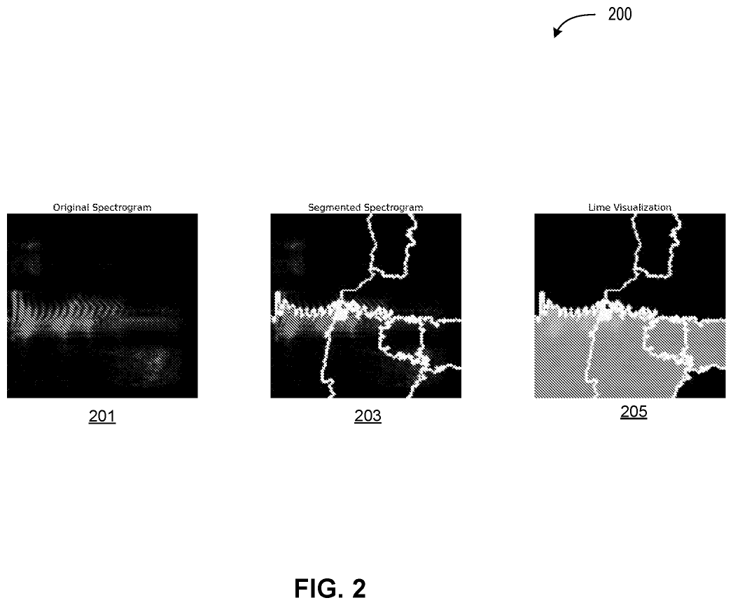

FIG. 2 illustrates an example LIME (Local Interpretable Model Agnostic Explanations) visualization process 200, in accordance with some implementations of the present disclosure. FIG. 2 is described in detail with respect to FIGS. 3-4 herein below.

FIG. 3 is a flow diagram of an example method 300 for managing data drift in neural networks using incremental learning and explainability, in accordance with some implementations of the present disclosure. Method 300 may be performed by processing logic that comprises hardware (e.g., circuitry, dedicated logic, programmable logic, microcode), software (e.g., instructions run on a processing device to perform hardware simulation), or a combination thereof. In some embodiments, data drift management component 120 of FIG. 1 may perform some, or all of the operations described herein.

Method 300 begins at block 301, where the processing logic trains a machine learning model with one or more data samples (e.g., one or more data samples xₜᵣ, yₜᵣ as illustrated in FIG. 3). In some implementations, training the machine learning model can include feeding an input signal into the machine learning model, where the input signal includes data representing the one or more data samples. In some implementations, the machine learning model can be a deep neural network model (i.e., DNN model) and/or a very deep convolutional network model (i.e., VGG model).

At block 303, the processing logic validates the trained machine learning model. In some implementations, validating the trained machine learning model can be performed using one or more new data samples (e.g., one or more data samples xᵥₐₗ, yᵥₐₗ as illustrated in FIG. 3). In some implementations, validating can include any current, present, and/or future validation methods utilized in fields related to machine learning models, such as random subsampling, bootstrapping, nested cross-validation, K-fold cross-validation, etc.

At block 305, the processing logic identifies one or more correctly predicted (e.g., x_{val_cor}, y_{val_cor} as illustrated in FIG. 3) and/or incorrectly predicted data samples (e.g., x_{val_wrong}, y_{val_wrong} as illustrated in FIG. 3). In some implementations, the processing logic identifies the one or more correctly predicted and/or incorrectly predicted data samples in response to validating the trained machine learning model. In some implementations, the one or more correctly predicted and/or incorrectly predicted data samples can be obtained as an output from the trained machine learning model. In some implementations, the output can be an output signal. The output signal can include data representing the one or more correctly predicted and/or incorrectly predicted data samples. At block 307, the processing logic can perform scoring of each of the one or more correctly predicted and/or incorrectly predicted data samples, e.g., by comparing the performance (e.g., the number of correctly predicted and incorrectly predicted data samples) of the trained machine learning model using the one or more data samples with the performance of previous trainings of the machine learning model.

At block 309, the processing logic uses an explainability tool to generate a weighted value for each of the incorrectly predicted data samples obtained from the machine learning model at block 305. The weighted value can refer to a feature importance score for each data sample of the incorrectly predicted data samples. In some implementations, the explainability tool can be an explainable AI (i.e., artificial intelligence) tool such as local interpretable model-agnostic explanation (LIME), gradient-weighted class activation mapping (GradCAM), SHapley Additive, and the like, where the explainability tool can be used as a feedback loop and to provide explainable visuals of a heatmap overlayed on top of an image according to either weight and/or gradient activation. In some implementations, generating the weighted value can include generating, using a LIME visual, a spectrogram of an image and/or raw audio, etc. For example, referring to FIG. 2, the spectrogram generated can refer to a spectrogram 201 as illustrated in FIG. 2. In some implementations, generating the weighted value can further include segmenting the spectrogram into one or more segments. For example, referring to FIG. 2, the processing logic can segment the spectrogram into one or segments, as illustrated by a segmented spectrogram 203 in FIG. 2.

In some implementations, the processing logic can segment the spectrogram into the one or more segments using a clustering algorithm. The clustering algorithm can refer to any algorithm that performs cluster analysis in machine learning, such as to divide and/or group data into one or more groups where the data in one group are more similar to other data in the same group and dissimilar to data in another group. For example, the clustering algorithm can be a density-based clustering algorithm, a distribution-based clustering algorithm, a centroid-based clustering algorithm, a hierarchical-based clustering algorithm, a K-means clustering algorithm, a Gaussian mixture model clustering algorithm, a Balance Iterative Reducing and Clustering using Hierarchies (BIRCH) clustering algorithm, an affinity propagation clustering algorithm, and/or a mean-shift clustering algorithm, etc.

In some implementations, in response to segmenting the spectrogram into one or more segments, the processing logic can generate a variation of the spectrogram, where each segment of the one or more segments is associated with a respective configuration according to a binomial distribution. For example, each segment of the one or more segments can be associated (e.g., assigned, set, etc.) with either a visible or invisible (e.g., on or off) mode. Referring to FIG. 2, the generated variation of the spectrogram can be illustrated as a LIME visualization 205 in FIG. 2. The greyed-out clusters in the spectrogram 205 can refer to the most influential (e.g., important) clusters. In some implementations, the processing logic generates the variation of the spectrogram by performing a perturbation process. The perturbation process can be any method supported in machine learning that utilizes perturbation techniques as known to one reasonably skilled in the art.

In some implementations, in response to generating the variation of the spectrogram, the processing logic can input the variation of the spectrogram into the trained machine learning model (e.g., the processing logic can feed the variation of the spectrogram as an input signal into the trained machine learning model) to predict one or more classes (e.g., classifications) of the variation. The processing logic can obtain, from the trained machine learning model, an output signal that specifies one or more classification predictions for the variation of the spectrogram. For example, the output signal can be data that includes the one or more classification predictions for the variation of the spectrogram.

In some implementations, the processing logic, in response to obtaining the output signal, can determine a distance between the variation of the spectrogram (e.g., the spectrogram 205 of FIG. 2) and the original spectrogram (e.g., the spectrogram 201 of FIG. 2). Determining the distance between the variation of the spectrogram and the original spectrogram can include determining a cosine- and/or Euclidean- and/or Manhattan-based distance between the variation of the spectrogram and the original spectrogram.

In some implementations, in response to determining the distance, the processing logic can determine the weighted value for each data sample (e.g., each incorrectly predicted data sample obtained at block 305) by fitting a linear regression classifier model on the variation of the spectrogram and the one or more classification predictions. The processing logic can use the determined distance between the variation of the spectrogram and the original spectrogram as a weight in the linear regression classifier model. In some implementations, each coefficient of the linear regression classifier model can be the weighted value for each data sample. In some implementations, an example algorithm for generating the weighted value for each data sample can be the following:

$$Require : {X}_{in} , {θ}^{t}$$

$$C = Cluster ( {X}_{i n} )$$

$$var ← [ null ] , σ = 0.25$$

$$for i in [ 1 , 2 , … n ] do$$

$$V = Peturbation ( C )$$

$$var . append ( V )$$

$$end for$$

$$pred = Predict ( {θ}^{t} , var )$$

$$dist = Cosine Distance ( {X}_{i n} , var )$$

$$w = \sqrt{{e}^{( - \frac{{dist}^{2}}{{σ}^{2}} )}}$$

$$reg = Linear Regression ( var , pred , wt )$$

$$score = coeff ( reg )$$

where σ refers to a kernel width and can be set to any value, such as 0.25.

In some implementations, an example equation for generating the weighted value can be the following:

$${\sum }_{i = 0}^{i = n} {( {L}_{p}^{i} - {L}_{t}^{i} )}^{2} , n = \# segments / features$$

where (Lₚⁱ−Lₜⁱ)² can refer to the Euclidean distance between the variation of the spectrogram (Lₜⁱ) and the prediction classification of the spectrogram (Lₚⁱ), n refers to a number (e.g., a total number, count, value, etc.) of the one or more segments of the spectrogram.

At block 311, the processing logic retrains the machine learning model using the weighted value generated at block 309. In some implementations, retraining the machine learning model can include multiplying the weighted value, generated at block 309, to each data sample (e.g., the incorrectly predicted data samples obtained at block 305) to compute a modified set of data samples. In some implementations, an example equation for retraining the machine learning model using the modified set of data samples can be the following:

$$- ( {\sum }_{i = 1}^{output size} {y}_{i} \cdot log \hat{{y}_{l}} ) \cdot weighted value$$

In some implementations, retraining the machine learning model can include additively applying (e.g., adding) the weighted value generated at block 309 to each data sample (e.g., the incorrectly predicted data samples obtained at block 305) in order to compute the modified set of data samples. In some implementations, an example equation for retraining the machine learning model using the modified set of data samples can be the following:

$$- ( {\sum }_{i = 1}^{output size} {y}_{i} \cdot log \hat{{y}_{l}} ) \cdot weighted value$$

In some implementations, the processing logic can retrain the machine learning model by applying a regularization parameter in addition to multiplying and/or additively applying the weighted value to each data sample as described above. For example, the regularization parameter can be an elastic weight consolidation (EWC) parameter, where score importance can be based on a fisher information matrix (FIM). FIM refers to information that an observable random variable X carries about an unknown parameter θ which can model the distribution of X. In some implementations, the EWC parameter can be used to address catastrophic forgetting and allow the machine learning model to retain previously learned information in addition to adding new information (e.g., data samples), as discussed in more detail herein. In some implementations, the regularization parameter can be applied to the weighted value generated using an equation such as the following:

$$Loss = {Loss}_{p} + {\sum }_{i} \frac{λ}{2} {{F}_{i} ( {θ}_{i} - {θ}_{prev} )}^{2}$$

where Lossₚ refers to the weighted value generated at block 309, F(θᵢ) refers to the fisher information matrix (FIM) from parameters of the one or more data samples (e.g., the one or more data samples currently used to train the machine learning model), F (θₚᵣₑᵥ) refers to the FIM from parameters of one or more data samples used in previous trainings of the machine learning model, i refers to a size (e.g., a count, a total number, a total value, etc.) of the one or more data samples (e.g., the one or more data samples currently used to train the machine learning model), and λ refers to a value (e.g., 1) that controls the amount of EWC regularization applied to Lossₚ.

FIG. 4 is a flow diagram of an example method 400 for managing data drift in neural networks using incremental learning and explainability, in accordance with some implementations of the present disclosure. Method 400 may be performed by processing logic that comprises hardware (e.g., circuitry, dedicated logic, programmable logic, microcode), software (e.g., instructions run on a processing device to perform hardware simulation), or a combination thereof. In some embodiments, data drift management component 120 of FIG. 1 may perform some, or all of the operations described herein.

Method 400 begins at block 410, where the processing logic obtains an output (e.g., an output signal) from a machine learning model. The output can include one or more data samples. In some implementations, the machine learning model can be a deep neural network model (i.e., DNN model) and/or a very deep convolutional network model (i.e., VGG model).

At block 420, the processing logic identifies a set of data samples of the one or more data samples included in the output. In some implementations, identifying the set of data samples of the one or more data samples can include identifying each data sample of the one or more data samples that satisfies a threshold criterion. In some implementations, the threshold criterion can be a misclassified data sample (e.g., an incorrectly predicted data sample). Identifying each data sample that satisfies the threshold criterion can include identifying each data sample that is a misclassified data sample.

At block 430, the processing logic generates a weighted value for each data sample of the set of data samples identified at block 420 (e.g., each data sample that is a misclassified data sample). The weighted value can refer to the weighted value referred to with respect to FIG. 3 at block 309. In some implementations, the processing logic generates the weighted value for each data sample of the set of data samples using an explainability tool. In some implementations, the explainability tool can refer to the explainability tool referred to with respect to FIG. 3 at block 309. In some implementations, generating the weighted value can be performed as described with respect to FIG. 3 at block 309.

At block 440, the processing logic modifies the machine learning model. In some implementations, the processing logic modifies the machine learning model based at least in part on the weighted value generated at block 430 for each data sample of the set of data samples. In some implementations, modifying the machine learning model can be performed as described with respect to retraining the machine learning model at block 311 of FIG. 3.

In some implementations, the processing logic can validate the modified machine learning model in response to modifying the machine learning model. Validating the modified machine learning model can be performed using one or more new data samples. In some implementations, validating can include any current, present, and/or future validation methods utilized in fields related to machine learning models, such as random subsampling, bootstrapping, nested cross-validation, K-fold cross-validation, etc.

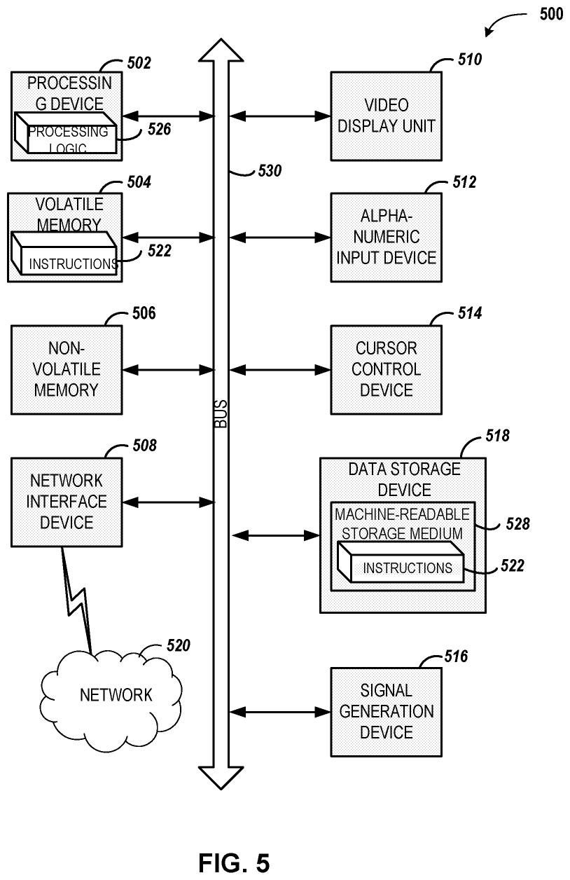

FIG. 5 depicts a block diagram of an example computing device 500, operating in accordance with one or more aspects of the present disclosure. In various illustrative examples, various components of the computing device 500 may represent various components of FIG. 1.

Example computing device 500 may be connected to other computer devices in a LAN, an intranet, an extranet, and/or the Internet. Computing device 500 may operate in the capacity of a server in a client-server network environment. Computing device 500 may be a personal computer (PC), a set-top box (STB), a server, a network router, switch or bridge, or any device capable of executing a set of instructions (sequential or otherwise) that specify actions to be taken by that device. Further, while only a single example computing device is illustrated, the term “computer” shall also be taken to include any collection of computers that individually or jointly execute a set (or multiple sets) of instructions to perform any one or more of the methods discussed herein.

Example computing device 500 may include a processing device 502 (also referred to as a processor or CPU), a main memory 504 (e.g., read-only memory (ROM), flash memory, dynamic random access memory (DRAM) such as synchronous DRAM (SDRAM), etc.), a static memory 506 (e.g., flash memory, static random access memory (SRAM), etc.), and a secondary memory (e.g., a data storage device 518), which may communicate with each other via a bus 530.

Processing device 502 represents one or more general-purpose processing devices such as a microprocessor, central processing unit, or the like. More particularly, processing device 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 502 may also be one or more special-purpose processing devices such as an application-specific integrated circuit (ASIC), a field-programmable gate array (FPGA), a digital signal processor (DSP), a network processor, or the like. In accordance with one or more aspects of the present disclosure, processing device 502 may be configured to execute instructions implementing methods 300 and 400 illustrated in FIGS. 3-4.

Example computing device 500 may further comprise a network interface device 508, which may be communicatively coupled to a network 520. Example computing device 500 may further comprise a video display 510 (e.g., a liquid crystal display (LCD), a touch screen, or a cathode ray tube (CRT)), an alphanumeric input device 512 (e.g., a keyboard), a cursor control device 514 (e.g., a mouse), and an acoustic signal generation device 516 (e.g., a speaker).

Data storage device 518 may include a machine-readable storage medium (or, more specifically, a non-transitory computer-readable storage medium) 528 on which is stored one or more sets of executable instructions 522. In accordance with one or more aspects of the present disclosure, executable instructions 522 may comprise executable instructions associated with executing methods 300 and 400 illustrated in FIGS. 3-4.

Executable instructions 522 may also reside, completely or at least partially, within the main memory 504 and/or within the processing device 502 during execution thereof by the example computing device 500, main memory 504, and processing device 502 also constituting computer-readable storage media. Executable instructions 522 may be transmitted or received over a network via the network interface device 508.

While the computer-readable storage medium 528 is shown in FIG. 5 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus may be specially constructed for the required purposes, or it may be a general-purpose computer system selectively programmed by a computer program stored in the computer system. Such a computer program may be stored in a computer-readable storage medium, such as, but not limited to, any type of disk, including optical disks, compact disc read-only memory (CD-ROMs), magnetic-optical disks, read-only memories (ROMs), random access memories (RAMs), erasable programmable read-only memory (EPROMs), electrically erasable programmable read-only memory (EEPROMs), magnetic disk storage media, optical storage media, flash memory devices, other types of machine-accessible storage media, or any type of media suitable for storing electronic instructions, each coupled to a computer system bus.

The methods and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages may be used to implement the teachings of the present disclosure.

It should be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

The implementations of methods, hardware, software, firmware, or code set forth above may be implemented via instructions or code stored on a machine-accessible, machine-readable, computer-accessible, or computer-readable medium, which are executable by a processing element. “Memory” includes any mechanism that provides (i.e., stores and/or transmits) information in a form readable by a machine, such as a computer or electronic system. For example, “memory” includes random-access memory (RAM), such as static RAM (SRAM) or dynamic RAM (DRAM); ROM; magnetic or optical storage medium; flash memory devices; electrical storage devices; optical storage devices; acoustical storage devices, and any type of tangible machine-readable medium suitable for storing or transmitting electronic instructions or information in a form readable by a machine (e.g., a computer).

Reference throughout this specification to “one implementation” or “an implementation” means that a particular feature, structure, or characteristic described in connection with the implementation is included in at least one implementation of the disclosure. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

In the foregoing specification, a detailed description has been given with reference to specific exemplary implementations. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of implementation, implementation, and/or other exemplarily language does not necessarily refer to the same implementation or the same example, but may refer to different and distinct implementations, as well as potentially the same implementation.

The words “example” or “exemplary” are used herein to mean serving as an example, instance, or illustration. Any aspect or design described herein as “example’ or “exemplary” is not necessarily to be construed as preferred or advantageous over other aspects or designs. Rather, the use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. Also, the terms “first,” “second,” “third,” “fourth,” etc. as used herein are meant as labels to distinguish among different elements and may not necessarily have an ordinal meaning according to their numerical designation.

1. A method comprising:
obtaining, by a processing device, a first output from a machine learning model, wherein the first output comprises one or more data samples;
identifying a first set of data samples of the one or more data samples that satisfies a threshold criterion;
generating, using an explainability tool, a weighted value for each data sample of the first set of data samples; and
modifying the machine learning model based at least in part on the weighted value for each data sample of the first set of data samples.

2. The method of claim 1, wherein identifying the first set of data samples that satisfies the threshold criterion comprises identifying one or more misclassified data samples of the one or more data samples.

3. The method of claim 1, wherein generating the weighted value for each data sample using the explainability tool comprises:
generating, using a local interpretable model-agnostic explanation (LIME) visual, a spectrogram of an image;
segmenting, using a clustering algorithm, the spectrogram into one or more segments;
generating, by performing a perturbation process, a variation of the spectrogram, wherein each segment of the one or more segments is associated with a respective configuration;
inputting the variation of the spectrogram into the machine learning model;
obtaining, from the machine learning model, a second output specifying one or more classification predictions for the variation of the spectrogram;
determining a distance between the variation of the spectrogram and the spectrogram; and
determining the weighted value of each data sample based on fitting a linear regression model on the variation of the spectrogram and the one or more classification predictions, wherein the distance between the variation of the spectrogram and the spectrogram is used as a weight in the linear regression model.

4. The method of claim 1, further comprising:
validating the modified machine learning model using one or more new data samples.

5. The method of claim 1, wherein modifying the machine learning model comprises:
modifying the first set of data samples by multiplying the weighted value to each data sample of the first set of data samples; and
retraining the machine learning model using the modified first set of data samples.

6. The method of claim 1, wherein modifying the machine learning model comprises:
modifying the first set of data samples by additively applying the weighted value to each data sample of the first set of data samples; and
retraining the machine learning model using the modified first set of data samples.

7. The method of claim 1, wherein modifying the machine learning model is further based on a regularization parameter.

8. A system comprising:
a memory; and
a processing device operatively coupled to the memory, wherein the processing device is to:
obtain a first output from a machine learning model, wherein the first output comprises one or more data samples;
identify a first set of data samples of the one or more data samples that satisfies a threshold criterion;
generate, using an explainability tool, a weighted value for each data sample of the first set of data samples; and
modify the machine learning model based at least in part on the weighted value for each data sample of the first set of data samples.

9. The system of claim 8, wherein identifying the first set of data samples that satisfies the threshold criterion comprises identifying one or more misclassified data samples of the one or more data samples.

10. The system of claim 8, wherein generating the weighted value for each data sample using the explainability tool comprises:
generating, using a local interpretable model-agnostic explanation (LIME) visual, a spectrogram of an image;
segmenting, using a clustering algorithm, the spectrogram into one or more segments;
generating, by performing a perturbation process, a variation of the spectrogram, wherein each segment of the one or more segments is associated with a respective configuration;
inputting the variation of the spectrogram into the machine learning model;
obtaining, from the machine learning model, a second output specifying one or more classification predictions for the variation of the spectrogram;
determining a distance between the variation of the spectrogram and the spectrogram; and
determining the weighted value of each data sample based on fitting a linear regression model on the variation of the spectrogram and the one or more classification predictions, wherein the distance between the variation of the spectrogram and the spectrogram is used as a weight in the linear regression model.

11. The system of claim 8, wherein the processing device is further to:
validate the modified machine learning model using one or more new data samples.

12. The system of claim 8, wherein modifying the machine learning model comprises:
modifying the first set of data samples by multiplying the weighted value to each data sample of the first set of data samples; and
retraining the machine learning model using the modified first set of data samples.

13. The system of claim 8, wherein modifying the machine learning model comprises:
modifying the first set of data samples by additively applying the weighted value to each data sample of the first set of data samples; and
retraining the machine learning model using the modified first set of data samples.

14. The system of claim 8, wherein modifying the machine learning model is further based on a regularization parameter.

15. A non-transitory computer-readable storage medium comprising instructions that, when executed by a processing device, cause the processing device to perform operations comprising:
obtaining, by the processing device, a first output from a machine learning model, wherein the first output comprises one or more data samples;
identifying a first set of data samples of the one or more data samples that satisfies a threshold criterion;
generating, using an explainability tool, a weighted value for each data sample of the first set of data samples; and
modifying the machine learning model based at least in part on the weighted value for each data sample of the first set of data samples.

16. The non-transitory computer-readable storage medium of claim 15, wherein identifying the first set of data samples that satisfies the threshold criterion comprises identifying one or more misclassified data samples of the one or more data samples.

17. The non-transitory computer-readable storage medium of claim 15, wherein generating the weighted value for each data sample using the explainability tool comprises:
generating, using a local interpretable model-agnostic explanation (LIME) visual, a spectrogram of an image;
segmenting, using a clustering algorithm, the spectrogram into one or more segments;
generating, by performing a perturbation process, a variation of the spectrogram, wherein each segment of the one or more segments is associated with a respective configuration;
inputting the variation of the spectrogram into the machine learning model;
obtaining, from the machine learning model, a second output specifying one or more classification predictions for the variation of the spectrogram;
determining a distance between the variation of the spectrogram and the spectrogram; and
determining the weighted value of each data sample based on fitting a linear regression model on the variation of the spectrogram and the one or more classification predictions, wherein the distance between the variation of the spectrogram and the spectrogram is used as a weight in the linear regression model.

18. The non-transitory computer-readable storage medium of claim 15, wherein the processing device is further to:
validate the modified machine learning model using one or more new data samples.

19. The non-transitory computer-readable storage medium of claim 15, wherein modifying the machine learning model comprises:
modifying the first set of data samples by multiplying the weighted value to each data sample of the first set of data samples; and
retraining the machine learning model using the modified first set of data samples.

20. The non-transitory computer-readable storage medium of claim 15, wherein modifying the machine learning model is further based on a regularization parameter.
